(19) United States
(12) Patent Application Publication
(10) Pub. No.: US 2008/0256795 A1
(43) Pub. Date: Oct. 23, 2008

(54) WIND TURBINE BLADE HAVING CURVED CAMBER AND METHOD OF MANUFACTURING SAME

(75) Inventor: Michael Edwards, Kelowna (CA)

Correspondence Address: TROUTMAN SANDERS LLP, 600 PEACHTREE STREET , NE, ATLANTA, GA, 30308, US

(73) Assignee: Windterra Systems Inc., Kelowna (CA)

(21) Appl. No.: 11/847,371

(22) Filed: Aug. 30, 2007

Related U.S. Application Data
(60) Provisional application No. 60/907,811, filed on Apr. 18, 2007.

(51) Int. Cl. B23P 15/04; B63H 1/26

(52) U.S. Cl. 29/889.21; 416/223 R

(57) ABSTRACT

A wind turbine blade for a vertical axis wind turbine (VAWT) having a curved camber and a method of manufacturing same is disclosed. The method of manufacturing a turbine blade comprises determining the profile of an airfoil of the blade and forming the blade having the airfoil with the translated profile. The step of determining the profile of an airfoil of the blade comprises selecting a symmetrical airfoil having a straight mean camber line and a desired chord length; selecting a circular segment having the same radius as a path traveled by the blade around a hub of the VAWT and locating the circular segment to contact the mean camber line at at least one point; translating the mean camber line of the symmetrical airfoil such that it overlaps with the circular segment; and determining the profile of the airfoil blade by translating the profile of the symmetrical airfoil to correspond with the translated mean camber line of the symmetrical airfoil.

### CROSS REFERENCE TO RELATED APPLICATION

This application claims benefit under 35 U.S.C. §119(e) of U.S. Provisional Patent Application Ser. No. 60/907,811 filed 18 Apr. 2007, the entire contents and substance of which is hereby incorporated by reference.

### FIELD OF THE INVENTION

The present invention relates to turbine blades for wind turbines, and particularly to vertical axis wind turbine (“VAWT”) blades having an airfoil with a curved camber, and a method of manufacturing same.

### BACKGROUND OF THE INVENTION

While wind turbines have been in use for a very long time, only recently has there been a commercially significant interest by individuals for using wind turbines to generate power for their homes. In part, this increased interest is due to rising energy costs, environmental concerns, and lower costs for wind turbines. As a result of this increased interest in wind power, many new designs of wind turbines have been created. Notwithstanding this innovation, wind turbines can still be generally classified as either horizontal axis wind turbines (“HAWTs”) or VAWTs.

Both HAWTs and VAWTs generate power through the rotation of turbine blades about a hub. In HAWTs, the hub is horizontal relative to the ground; in VAWTs, the hub is vertical relative to the ground. Another difference between HAWTs and VAWTs is the type of airfoil used. It is not advisable to use an airfoil suitable for a HAWT on a VAWT, or vice-versa. Each type of turbine utilizes a specific airfoil design that matches its operational characteristics. The airfoil of a HAWT blade, for example, generally has a large root and tapers towards its tip. It also generally twists along its length to keep its angle of attack relatively constant.

VAWTs utilize blades operate on the principle of lift and travel in a circular path and thus require an airfoil that is different from that of HAWTs. Traditionally, a symmetrical airfoil is used with VAWTs since the angle of attack of the airfoils vary between a positive and negative number of same amount over the course of a full rotation about the VAWT's hub (an example of a symmetrical airfoil is shown in FIG. 1 “PRIOR ART”).

By “symmetrical”, it is meant that the mean camber line of the airfoil is straight and is the same as the chord line of the airfoil. Examples of VAWTs in the prior art disclosing symmetrical airfoils can be found in U.S. Pat. No. 4,204,805 and U.S. Pat. No. 4,087,202, and are well known to persons skilled in the art. For the case in which the chord line of the airfoil is perpendicular to the radius of the circular path traveled by the airfoil, at any fixed point in time, the traditional presumption is that the headwind encountered by a symmetrical airfoil is parallel to the airfoil's chord line. “Headwind” in this context means the wind generated solely on account of the blade's own motion. The traditional presumption, however, fails to account for the fact that the airfoil is traveling along a circular path. Because the airfoil travels along a circular path, the headwind encountered by the airfoil is not parallel with the airfoil's chord line, but instead has a component that is transverse to it. The traditional presumption is therefore not accurate, and consequently symmetrical airfoils are not optimized to harness wind energy when used with VAWTs.

Non-symmetrical airfoils for VAWT are also known. For example, U.S. Pat. No. 4,285,636 discloses a non-symmetrical airfoil for a VAWT blade which has a mean camber line that has a downward convex curvature between a leading edge and a camber reversing point, then an upward convex curvature from the camber reversing point to the trailing edge. Such a non-symmetrical airfoil is designed to achieve a large negative pitching moment coefficient, and small drag coefficient. The disadvantage to such a non-symmetrical airfoil is that the torque curve generated by the blade as it completes a full rotation about the hub is no longer symmetrical about the 180 degree point, as it is for symmetrical blades. By “torque curve”, it is meant the graph of torque imparted by the blade on the hub vs. location of the blade about the hub, measured in degrees. The benefit of a torque curve that repeats every 180 degrees versus one that repeats only once every 360 degrees (i.e.: once per rotation) is that the torque fluctuations that the VAWT must endure are reduced, which consequently decreases the vibrations and strain that the VAWT must be constructed to withstand. Therefore, VAWTs manufactured with non-symmetrical blades known in the prior art experience greater fluctuations in torque than do VAWTs manufactured with symmetrical blades. As a result, the former are subjected to more vibrations and mechanical strain than the latter. This increases manufacturing and operating costs as VAWTs subjected to greater strains must be constructed more robustly and more extensively maintained.

What is needed, therefore, is a VAWT blade having an airfoil that is more efficient than the airfoils available today, which reduces torque fluctuations as compared to known non-symmetrical blades, and a method of manufacturing a blade having such an airfoil.

### SUMMARY OF THE INVENTION

It is an object of the invention to provide a turbine blade for a VAWT with an airfoil that results in the turbine blade being more efficient than traditional symmetrical blades, yet which reduces torque fluctuations better than known non-symmetrical blades, and a method for manufacturing thereof.

According to a first aspect of the invention, there is provided a method of manufacturing a turbine blade for a vertical axis wind turbine (VAWT) comprising determining the profile of an airfoil of the blade and forming the blade having the airfoil with the translated profile. The step of determining the profile of an airfoil of the blade comprises selecting a symmetrical airfoil having a straight mean camber line and a desired chord length; selecting a circular segment having the same radius as a path traveled by the blade around a hub of the VAWT and locating the circular segment to contact the mean camber line at least one point; translating the mean camber line of the symmetrical airfoil such that it overlaps with the circular segment; and determining the profile of the airfoil blade by translating the profile of the symmetrical airfoil to correspond with the translated mean camber line of the symmetrical airfoil.

The step of translating the mean camber line of the symmetrical airfoil may further comprise translating every point on the mean camber line of the symmetrical airfoil perpendicular to itself such that every point overlaps with a corresponding point on the circular segment. The step of translating the profile of the symmetrical airfoil may further comprise translating every point on the profile of the symmetrical airfoil in the same direction and by the same distance as a corresponding point on the mean camber line was translated.

Alternatively, the step of translating the mean camber line of the symmetrical airfoil may comprise translating the mean camber line of the symmetrical airfoil radially such that every point overlaps with a corresponding point on the circular segment. The step of translating the profile of the symmetrical airfoil may comprise translating every point on the profile radially such that the mean camber line of the translated airfoil coincides with the circular segment.

The method of manufacturing a turbine blade may further comprise selecting a desired attachment point of the blade airfoil to an arm of the VAWT, then overlaying the symmetrical airfoil and the circular segment such that the attachment point of the symmetrical airfoil contacts the circular segment and the chord of the symmetrical airfoil is tangent to the circular segment. The arm can be positioned substantially parallel to one of the x, y, or z axes in computer aided drawing software used to determine the profile of the blade.

According to a further aspect of the invention, there is provided a method of manufacturing a turbine blade for a VAWT comprising determining the profile of the blade by selecting a symmetrical airfoil having a straight mean camber line and a desired chord length, c; selecting a circular segment having the same radius, R, as a path traveled by the blade around a hub of the VAWT; orienting the symmetrical airfoil using Cartesian coordinates such that the leading edge of the symmetrical airfoil is located at (x,y)=(0,0) and such that the chord terminates at (c,0); selecting a desired attachment point, A, of the blade airfoil to an arm of the VAWT, A being expressed as a percentage of the chord length, c, as measured from the leading edge of the blade airfoil; for each point (x,y) of the straight mean camber line, calculating a translated point (x_{mod}, y_{mod}) according to the following equations

$${x}_{mod} = x ;$$

$${y}_{mod} = y - [ R - R cos ( {sin}^{- 1} ( \frac{\vert x - Ac \vert}{R} ) ) ] ; and$$

determining the profile of the blade airfoil by vertically translating the profile of the symmetric airfoil to correspond with the translated mean camber line of the symmetrical airfoil. The blade having the airfoil with the determined profile is then formed.

According to a still further aspect of the invention, there is provided a method of manufacturing a turbine blade for a VAWT comprising determining the profile of an airfoil of the blade by selecting a symmetrical airfoil having a straight mean camber line and a desired chord length, c; selecting a circular segment having the same radius, R, as a path traveled by the blade around a hub of the VAWT; orienting the symmetrical airfoil using Cartesian coordinates such that the leading edge of the symmetrical airfoil is located at (x,y)=(−A·c,R) and such that the chord terminates at (c−A·c,R); selecting a desired attachment point, A, of the blade airfoil to an arm of the VAWT, A being expressed as a percentage of the chord length, c, as measured from the leading edge of the blade airfoil; and for each point (xₐ,yₐ) of the profile of the blade airfoil, where (xₐ,yₐ) represents the profile of the blade airfoil in Base 100, calculating a translated point (x_{mod}, y_{mod}), which represents a point relative to the origin of the Cartesian grid at (0,0), according to the following equations:

$${x}_{mod} = ( R + {y}_{a} ) \cdot \frac{{x}_{a} - Ac}{R} ;$$

$${y}_{mod} = ( R + {y}_{a} ) \cdot sin [ {cos}^{- 1} \frac{{x}_{a} - Ac}{R} ] .$$

The blade having the airfoil with the determined profile is then formed.

According to another aspect of the invention, there is provided a blade for a VAWT having an airfoil with a substantially circular mean camber line. “Substantially circular” refers to the shape of the mean camber line of the non-symmetrical blade that results when the profile of a symmetrical blade is translated perpendicularly to the straight mean camber line of the symmetrical blade. The circular mean camber line of the blade may have the same radius as a circular path traveled by the blade around a hub of the VAWT. The blade may further comprise means for attaching an arm to the blade. When an arm is attached to the blade, the circular mean camber line of the blade may coincide with the circular path.

A detailed description of an exemplary embodiment of the present invention follows. It is to be understood, however, that the invention is not to be construed as limited to this embodiment.

### BRIEF DESCRIPTION OF THE DRAWINGS

FIG. 1 is a schematic side elevation view of a symmetrical airfoil blade superimposed on a circular path traversed by the blade as it rotates about a hub (PRIOR ART).

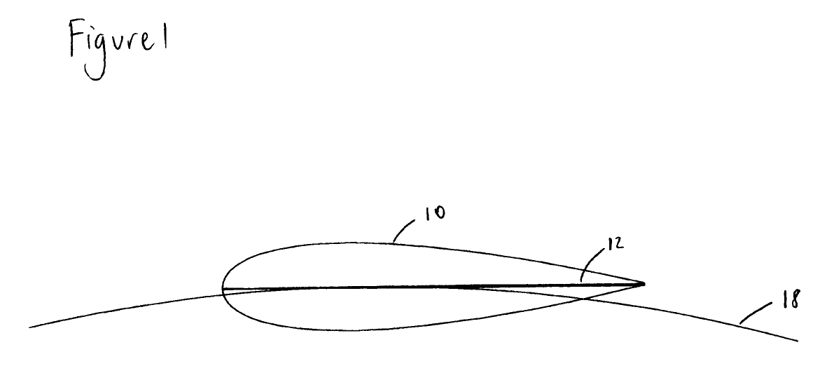

FIG. 2A is a perspective view of a VAWT comprising a hub and multiple blade assemblies attached thereto.

FIG. 2B is a top plan view of a VAWT comprising a hub and multiple blade assemblies attached thereto.

FIG. 3 is a schematic side elevation view of a VAWT blade having a curved mean camber line aligned with a circular path according to a first embodiment of the invention.

FIG. 4 is a schematic side elevation view of the blade manufactured according to the first embodiment attached to an arm of the VAWT at a first position.

FIG. 5 is a schematic side elevation view of the blade manufactured according to the first embodiment attached to the arm of the VAWT at a second position.

FIG. 6 is a schematic side elevation view of an airfoil transformed from a symmetrical airfoil (shown superimposed) by a manufacturing method according to the first embodiment.

FIG. 7 is a schematic side elevation view of an airfoil manufactured according to a second embodiment of the invention, superimposed on an airfoil transformed according the first embodiment of the invention.

### DETAILED DESCRIPTION OF EXEMPLARY EMBODIMENTS

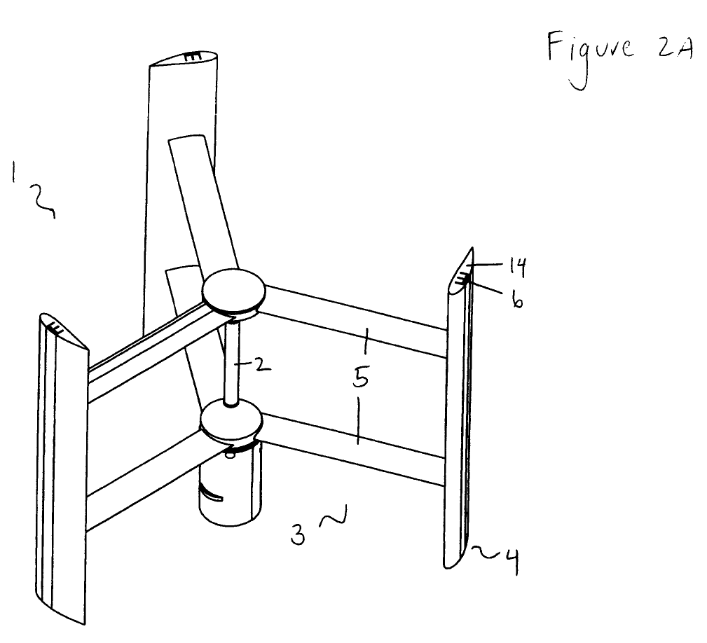

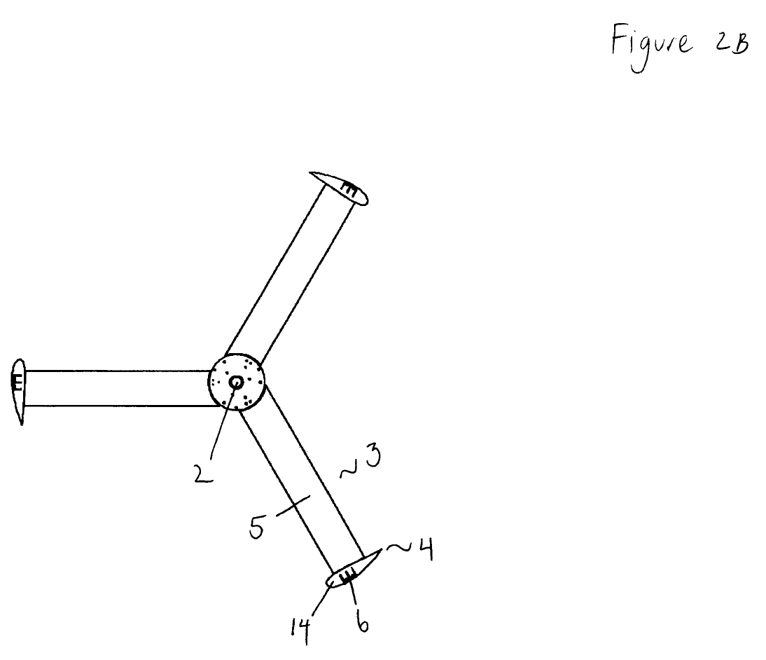

Referring to FIGS. 2A and 2B and according to one embodiment of the invention, a VAWT 1 includes a vertically extending hub 2 and multiple blade assemblies 3 attached to the hub 2. Each blade assembly 3 comprises a turbine blade 4 and a pair of horizontally extending arms 5 each attached perpendicularly to the vertically extending blade 4 such that the arms 5 are vertically spaced apart from each other.

Each blade 4 comprises an elongated frame 6 and an airfoil 14 in which the frame 6 is embedded. In this embodiment, the frame 6 is constructed from two 1″×½″×⅛″ thick angle extrusions (6063 T5 Aluminum) on the outside and a single 1″×⅛″ thick flat bar extrusion (same material) running down the center. The airfoil 14 comprises a CNC cut Type II EPS foam coated with a polyurethane spray at a thickness of 1/16″. The frame 6 is glued to the airfoil 14 by a polyurethane glue. However, other suitable means of constructing the blade 4 as known in the art can be substituted within the scope of this invention.

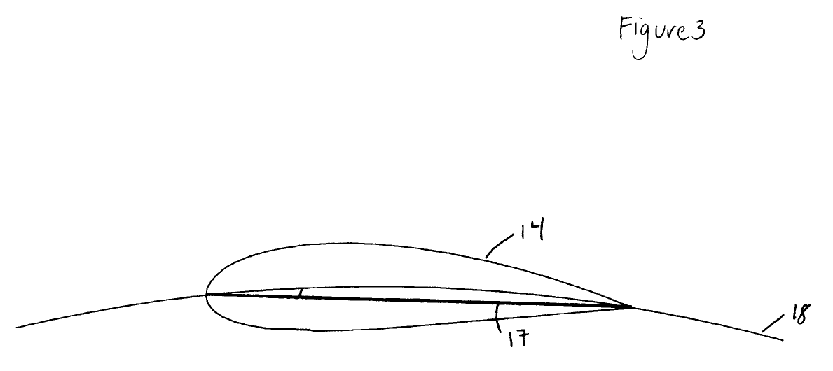

Referring to FIG. 3, the airfoil 14 has characteristics that enable the blade 4 to harness wind energy in a particularly efficient manner. The airfoil 14 has a mean camber line (not shown) that closely approximates the radius of a circular path 18 defined by the blade's path around a hub (not shown) of the VAWT. Consequently, as the blade rotates, the headwind encountered by the blade is always parallel to an imaginary normal line extending from the leading edge of the blade. The blade 4 is mounted on the arms 5 such that the mean camber line closely approximates the circular path 18.

The increased efficiency of the non-symmetrical blade relative to a traditional symmetrical blade is evident from the data contained in Table 1. Table 1 shows the power generated by both a symmetrical blade and a non-symmetrical blade manufactured by the method of the present embodiment of the invention for a range of wind speeds. The symmetrical blade used is one having a commercially available NACA0021 333 mm chord airfoil.

TABLE 1
Power Generated by Symmetrical Blade and Non-Symmetrical Blade
Manufactured with the Method of the Present Invention

| | Power generated from VAWT | Power generated from VAWT | |
|---|---|---|---|
| Wind Speed | using NACA0021 333 mm chord | using modified NACA0021 | % |
| (m/s) | airfoil (Watts) | 333 mm chord airfoil (Watts) | improvement |
| 3 | 39 | 50 | 28.2 |
| 4 | 62 | 89 | 43.5 |
| 5 | 91 | 143 | 57.1 |
| 6 | 161 | 232 | 44.1 |
| 7 | 299 | 352 | 17.7 |
| 8 | 396 | 463 | 16.8 |
| 9 | 499 | 677 | 35.7 |
| 10 | 700 | 927 | 32.4 |
| 11 | 918 | 1090 | 18.7 |
| 12 | 1116 | 1413 | 26.6 |
| 13 | 1276 | 1680 | 31.7 |
| 14 | 1506 | 1960 | 30.1 |

The average increase in power, and therefore efficiency, over all listed airspeeds is 31.9%, with a peak increase in power of 57.1% at a wind speed of 5 m/s.

In addition, theoretically, the torque curve for a non-symmetrical blade created by the method of the present invention repeats every 180 degrees, just as the torque curve for a symmetrical blade does. This is an improvement over non-symmetrical blades known in the prior art, whose torque curves repeat only once per cycle, or once every 360 degrees.

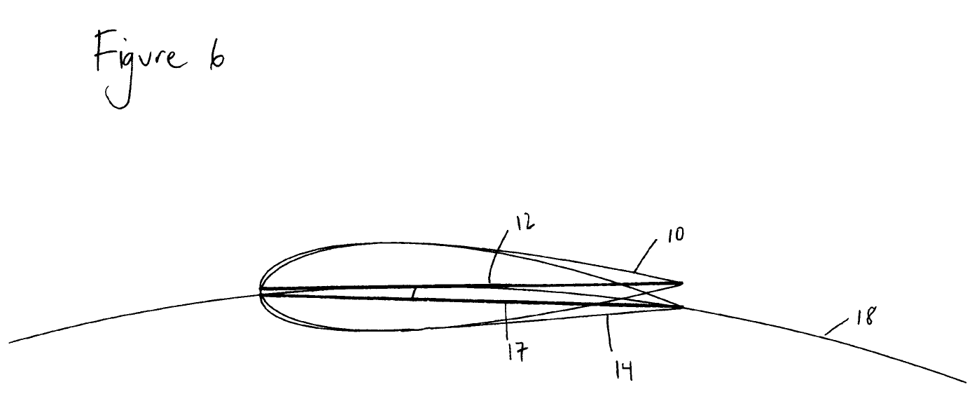

Referring to FIG. 6, the profile or curvature of the upper and lower airfoil 14 surfaces is determined by mathematically transforming a suitable symmetrical airfoil 10 having a straight mean camber line 12 into a non-symmetrical airfoil having the curved mean camber line (not shown), i.e. a mean camber line with a radius that closely approximates the circular path 18 of the blade 4. Certain symmetrical airfoils are chosen for transformation because of their desirable high lift-to-drag ratios and because they have a thickness that is suitable for manufacturing. An airfoil that is too thick increases tooling and parts costs, while an airfoil that is too thin will not have an internal structure robust enough to endure the forces encountered during rotation.

The method of transforming a suitable symmetrical airfoil 10 into the airfoil 14 of the present embodiment is now described. A designer first selects a suitable symmetrical airfoil 10 that is to be modified and specifies its straight mean camber line 12 using Cartesian or other suitable coordinates. The coordinates are such that the leading edge of the symmetrical airfoil 10 is specified as (0,0) and the symmetrical airfoil 10 extends along the positive portion of the ‘x’ axis. The coordinates of the translated mean camber line of the symmetrical airfoil 10 (x_{mod},y_{mod}) are determined by the following equation

$${x}_{mod} = x ; and \\ {y}_{mod} = y - [ R - R cos ( {sin}^{- 1} ( \frac{\vert x - Ac \vert}{R} ) ) ] \qquad ( eq . ( 1 ) )$$

where
(x,y) are the coordinates of the original mean camber line 12 of the symmetrical blade 10;
R is the radius of the circular path followed by the airfoils;
A is the percentage of the chord from the leading edge of the airfoil to where the center of the attachment point is for the arm 5; and
c is the chord length of the non-symmetrical airfoil 14.

The upper and lower surfaces of the airfoil are translated along the y-axis by the same amount and in the same direction as the mean camber line.

As shown in FIG. 3, the result of the transformation is a non-symmetrical airfoil 14, with a mean camber line (not shown) that closely approximates the circular path 18 followed by the airfoil. As the upper and lower surfaces of the symmetric airfoil 10 are translated vertically, and not radially, the translated mean camber line of the symmetric airfoil 10 is not the mean camber line of the non-symmetric airfoil 14.

Alternatively, the airfoil 14 can be formed without defining the attachment point to the blade:
1. Select a symmetrical airfoil 10 with a straight mean camber line 12. When the mean camber line 12 is defined as a horizontal line (y=constant) on an x-y graph, the upper and lower surfaces of the airfoil can be mapped as having a thickness t, defined at each point x by a line that extends perpendicularly from the mean camber line to the upper and lower surfaces of the airfoil, for the entire chord length of the symmetrical airfoil 10;
2. Superimpose the symmetrical airfoil 10 over a circular path to be traversed by the non-symmetrical airfoil 14 with radius R, such that the mean camber line 12 of the symmetrical airfoil 10 is perfectly horizontal (y=constant), touches the circular path at least one point, and for each point x has a portion of the circular path vertically offset from it; and
3. For each point x, translate the mean camber line of the symmetrical airfoil 10 vertically such that following the translations for all points x the translated mean camber line of the symmetrical airfoil 10 entirely overlaps with the circular path 18 with radius R. Then, the profile of the airfoil 14 can be plotted by vertically transforming the profile of the symmetric airfoil 10 to correspond with the translated mean camber line of the symmetrical airfoil 10. As the profile of the symmetric airfoil 10 is translated vertically, and not radially, the translated mean camber line of the symmetric airfoil 10 is not the mean camber line of the non-symmetric airfoil 14.

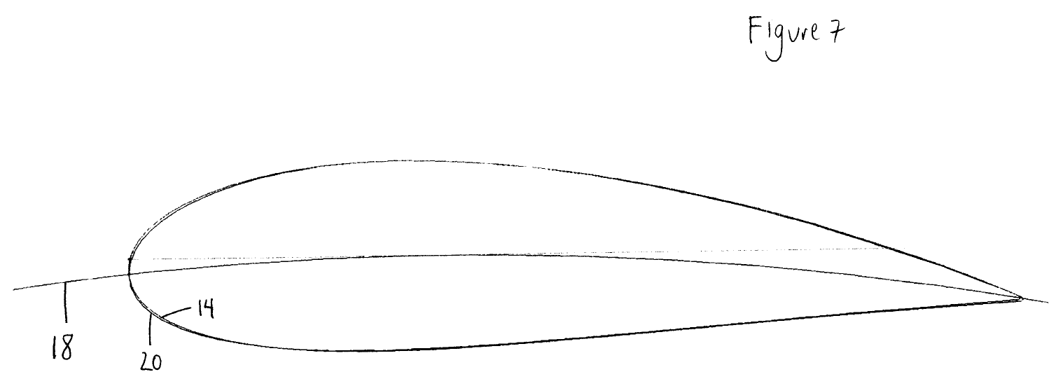

Referring now to FIG. 7, and according to a second embodiment of the invention, a non-symmetrical airfoil 20 can be designed with a mean camber line that exactly corresponds with a radius of a circular path defined by a blade's path around a hub of a VAWT. This embodiment of the invention also differs from the first embodiment of the invention in that the upper and lower surfaces of the airfoil 20 are not translated vertically by the same amount and in the same direction as the mean camber line of a symmetrical airfoil 10 is translated. Instead, the upper and lower surfaces of the airfoil are translated radially relative to the original symmetrical airfoil 10. Thus, the thickness of the symmetrical airfoil 10 at point x is the same as the thickness of the non-symmetrical airfoil 20 at corresponding translated point x_{mod}, where thickness is measured as the perpendicular distance from the mean camber line to the upper and lower surfaces of an airfoil.

FIG. 7 illustrates the minimal practical difference that exists between the airfoil 14 of the first embodiment of the invention and the airfoil 20 of the second embodiment of the invention. In both embodiments, the mean camber lines of the non-symmetrical airfoils 14, 20 match or closely approximate the circular path 18 followed by the blades. This makes the non-symmetrical blades of both embodiments of the invention significantly more efficient than the corresponding symmetrical blade. In practice, the difference between the airfoils 14, 20 is within manufacturing tolerances.

The method of transforming a suitable symmetrical airfoil 10 into the airfoil 20 of this second embodiment is now described. A designer first selects a suitable symmetrical airfoil 10 that is to be modified and specifies its straight mean camber line 12 using the Cartesian coordinate system, or any other suitable coordinate system. The leading edge of the symmetrical airfoil 10 is placed at (−A·c,R), and the origin of the Cartesian grid, (0,0), represents the location of the hub of the VAWT about which the symmetrical airfoil 10 rotates. A, c, and R represent the same values as they do in Equation 1. The mean camber line of the symmetrical airfoil 10 extends from (−A·c,R), parallel to the x-axis, in the direction of increasing values of ‘x’. The designer first determines the coordinates of the upper surface of the non-symmetrical airfoil (x_{mod},y_{mod}), relative to the origin of the Cartesian grid at (0,0), by using the following equations:

$$\begin{matrix}{x}_{mod} = ( R + {y}_{a} ) \cdot \frac{{x}_{a} - Ac}{R} & ( eq . ( 2 ) ) \\ {y}_{mod} = ( R + {y}_{a} ) \cdot sin [ {cos}^{- 1} \frac{{x}_{a} - Ac}{R} ] & ( eq . ( 3 ) )\end{matrix}$$

where xₐ and yₐ are in Base 100, which is a coordinate system well known to persons skilled in the art, in which the leading edge of an airfoil is represented by (xₐ,yₐ)=(0,0) and the trailing edge of an airfoil is represented by (xₐ,yₐ)=(100,0). In contrast with the first embodiment of the invention, in the second embodiment of the invention (xₐ,yₐ) do not represent the coordinates of the mean camber line of the symmetrical airfoil 10, but instead the coordinates of the upper surface of the symmetrical airfoil 10.

The designer then determines the coordinates of the lower surface of the non-symmetrical airfoil 20 by using Equations 2 and 3. In this case, xₐ and yₐ represent the coordinates of the lower surface of the symmetrical airfoil 10, x_{mod} and y_{mod} represent the coordinates of the lower surface of the non-symmetrical airfoil 20, again relative to the origin of the Cartesian grid at (0,0), and the remaining variables used in Equations 2 and 3 represent the same values as they do in Equation 1.

Alternatively, the airfoil 20 can be formed without defining the attachment point to the blade:
1. Select a symmetrical airfoil 10 with a straight mean camber line. When the mean camber line is defined as a horizontal line (y=constant) on an x-y graph, the upper and lower surfaces of the airfoil can be mapped as having a thickness t, defined at each point x by a line that extends perpendicularly from the mean camber line to the upper and lower surfaces of the airfoil, for the entire chord length of the symmetrical airfoil 10;
2. Superimpose the symmetrical airfoil 10 over a circular path to be traversed by the non-symmetrical airfoil 20 with radius R, such that the mean camber line of the symmetrical airfoil 10 is perfectly horizontal (y=constant), touches the circular path at least one point, and for each point x has a portion of the circular path vertically offset from it; and
3. For each point x, translate the mean camber line 12 of the symmetrical airfoil 10 radially such that following the translations for all points x the mean camber line entirely overlaps with the circular path with radius R. Then, the profile of the airfoil 20 can be plotted by radially transforming the profile of the symmetric airfoil 10 to correspond with the mean camber line of the blade airfoil. Because the profile is translated radially, the translated mean camber line of the symmetric airfoil 10 becomes the mean camber line of the non-symmetrical airfoil 20.

After the coordinates for the profile of the airfoil 14 or 20 are determined, these coordinates are input into a computer (not shown). A CNC machine (not shown) is coupled to the computer and receives instructions from the computer and drives a machine tool to cut the Type II EPS foam in a manner as is known in the art. After the foam is cut into the appropriate shape, it is coated with a polyurethane spray to form a rigid outer surface.

While this method is particularly suitable for forming the foam and polyurethane blade 4, other methods and materials as known in the art can be readily used to form the blade 4 with the airfoils 14, 20.

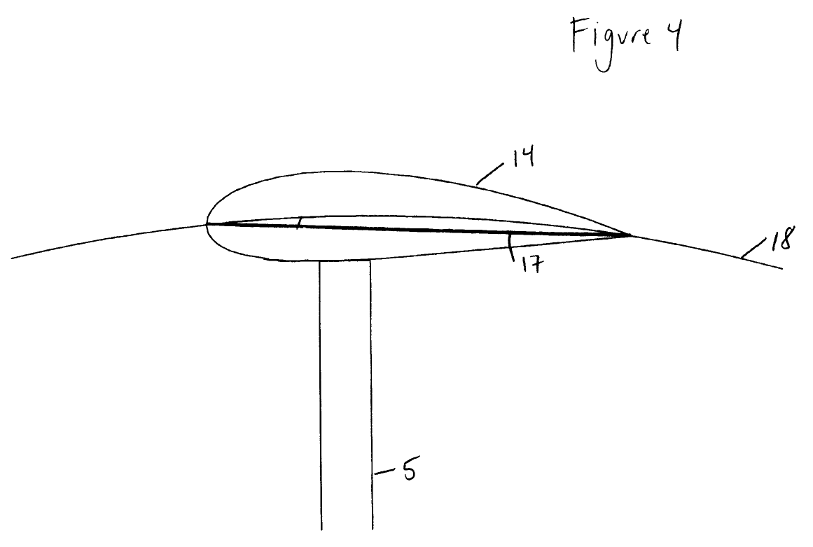

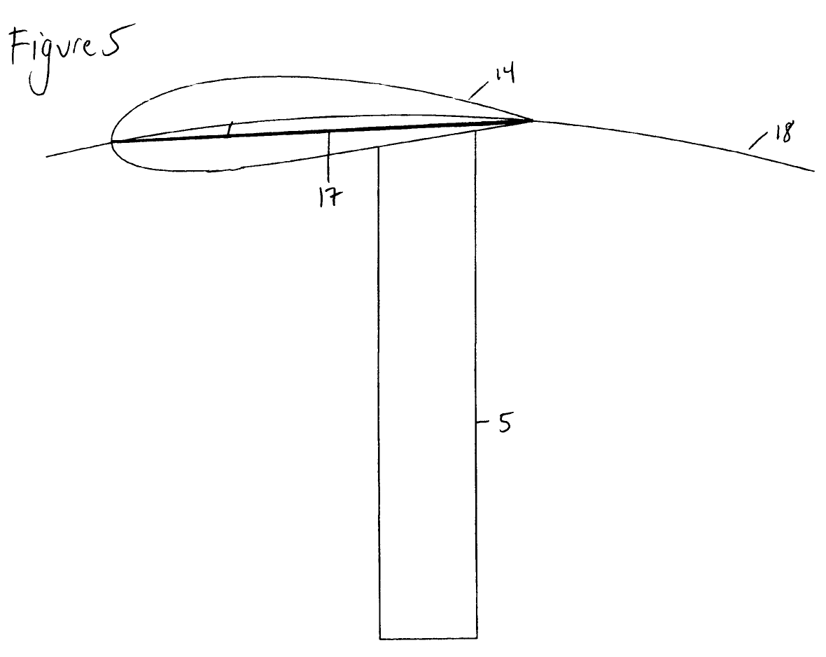

Referring now to FIGS. 4 and 5, after the blade 4 has been manufactured, it is attached to the arm 5 by a metal joint (not shown) or by other means as is known in the art. The end of the arm 5 is positioned relative to the blade 4 such that the center point of the arm end is located at distance A * c from the leading edge of the airfoil as determined in equation (1). Consequently, in the case of the blade generated by the method of the first embodiment, the circular mean camber line 16 of the non-symmetrical airfoil 14 very closely approximates the circular path 18. In the case of the blade generated by the method of the second embodiment, the circular mean camber line of the airfoil 20 is exactly aligned with the circular path 18. FIG. 4 shows the arm 5 attached to the blade 4 wherein distance A * c is a smaller value and hence the arm 5 is closer to the leading edge of the blade 4, and FIG. 5 shows the arm 5 attached to the blade 4 when distance A * c is a larger value and hence the arm 5 is closer to the trailing edge of the blade 4. One of the benefits of the present invention is that for all values of A * c, the arm can be plotted as being parallel to any of the x, y, or z axes when plotted in CAD software. Thus, a designer using CAD can easily orient the arm parallel to one of the axes and then import the airfoil and orient it accordingly.

While a particular embodiment of the present invention has been described in the foregoing, it is to be understood that other embodiments are possible within the scope of the invention and are intended to be included herein. It will be clear to any person skilled in the art that modifications of and adjustments to this invention, not shown, are possible without departing from the spirit of the invention as demonstrated through the exemplary embodiment. The invention is therefore to be considered limited solely by the scope of the appended claims.

What is claimed is:

1. A method of manufacturing a turbine blade for a vertical axis wind turbine (VAWT) comprising:
(a) determining the profile of an airfoil of the blade by
(i) selecting a symmetrical airfoil having a straight mean camber line and a desired chord length;
(ii) selecting a circular segment having the same radius as a path traveled by the blade around a hub of the VAWT and locating the circular segment to contact the mean camber line at least one point;
(iii) translating the mean camber line of the symmetrical airfoil such that it overlaps with the circular segment; and
(iv) determining the profile of the airfoil blade by translating the profile of the symmetrical airfoil to correspond with the translated mean camber line of the symmetrical airfoil; and
(b) forming the blade having the airfoil with the translated profile.

2. The method of manufacturing a turbine blade as claimed in claim 1 wherein
(a) the step of translating the mean camber line of the symmetrical airfoil comprises translating every point on the mean camber line of the symmetrical airfoil perpendicular to itself such that every point overlaps with a corresponding point on the circular segment; and
(b) the step of translating the profile of the symmetrical airfoil comprises translating every point on the profile of the symmetrical airfoil in the same direction and by the same distance as a corresponding point on the mean camber line was translated.

3. The method of manufacturing a turbine blade as claimed in claim 2 further comprising selecting a desired attachment point of the blade airfoil to an arm of the VAWT, then overlaying the symmetrical airfoil and the circular segment such that the attachment point of the symmetrical airfoil contacts the circular segment and the chord of the symmetrical airfoil is tangent to the circular segment.

4. The method of manufacturing a turbine blade as claimed in claim 3 wherein the arm can be positioned substantially parallel to one of the x, y, or z axes in computer aided drawing software used to determine the profile of the blade.

5. A method of manufacturing a turbine blade for a vertical axis wind turbine (VAWT) comprising:
(a) determining the profile of an airfoil of the blade by
(i) selecting a symmetrical airfoil having a straight mean camber line and a desired chord length, c;
(ii) selecting a circular segment having the same radius, R, as a path traveled by the blade around a hub of the VAWT;
(iii) orienting the symmetrical airfoil using Cartesian coordinates such that the leading edge of the symmetrical airfoil is located at (x,y)=(0,0) and such that the chord terminates at (c,0);
(iv) selecting a desired attachment point, A, of the blade airfoil to an arm of the VAWT, A being expressed as a percentage of the chord length, c, as measured from the leading edge of the blade airfoil;
(v) for each point (x,y) of the straight mean camber line, calculating a translated point (x_{mod}, y_{mod}) according to the following equations:
$${x}_{mod} = x ;$$
$${y}_{mod} = y - [ R - R cos ( {sin}^{- 1} ( \frac{\vert x - Ac \vert}{R} ) ) ] ; and$$
(vi) determining the profile of the blade airfoil by vertically translating the profile of the symmetric airfoil to correspond with the translated mean camber line of the symmetrical airfoil; then
(b) forming the blade having the airfoil with the determined profile.

6. The method of manufacturing a turbine blade as claimed in claim 1 wherein
(a) the step of translating the mean camber line of the symmetrical airfoil comprises translating every point on the mean camber line of the symmetrical airfoil radially such that every point overlaps with a corresponding point on the circular segment; and
(b) the step of translating the profile of the symmetrical airfoil comprises translating every point on the profile radially such that the mean camber line of the translated airfoil coincides with the circular segment.

7. The method of manufacturing a turbine blade as claimed in claim 6 further comprising selecting a desired attachment point of the blade airfoil to an arm of the VAWT, then overlaying the symmetrical airfoil and the circular segment such that the attachment point of the symmetrical airfoil contacts the circular segment and the chord of the symmetrical airfoil is tangent to the circular segment.

8. The method of manufacturing a turbine blade as claimed in claim 7 wherein the arm can be positioned substantially parallel to one of the x, y, or z axes in computer aided drawing software used to determine the profile of the blade.

9. A method of manufacturing a turbine blade for a vertical axis wind turbine (VAWT) comprising:
(a) determining the profile of an airfoil of the blade by
(i) selecting a symmetrical airfoil having a straight mean camber line and a desired chord length, c;
(ii) selecting a circular segment having the same radius, R, as a path traveled by the blade around a hub of the VAWT;
(iii) orienting the symmetrical airfoil using Cartesian coordinates such that the leading edge of the symmetrical airfoil is located at (x,y)=(−A·c,R) and such that the chord terminates at (c−A·c,R);
(iv) selecting a desired attachment point, A, of the blade airfoil to an arm of the VAWT, A being expressed as a percentage of the chord length, c, as measured from the leading edge of the blade airfoil; and
(v) for each point (xₐ,yₐ) of the profile of the blade airfoil, where (xₐ,yₐ) represents the profile of the blade airfoil in Base 100, calculating a translated point (x_{mod}, y_{mod}), which represents a point relative to the origin of the Cartesian grid at (0,0), according to the following equations:
$${x}_{mod} = ( R + {y}_{a} ) \cdot \frac{{x}_{a} - Ac}{R} ;$$
$${y}_{mod} = ( R + {y}_{a} ) \cdot sin [ {cos}^{- 1} \frac{{x}_{a} - Ac}{R} ] ; then$$
(b) forming the blade having the airfoil with the determined profile.

10. A blade for a vertical axis wind turbine (VAWT) having an airfoil with a substantially circular mean camber line.

11. The blade as claimed in claim 10 wherein the circular mean camber line has the same radius as a circular path traveled by the blade around a hub of the VAWT.

12. The blade as claimed in claim 10 further comprising means for attaching an arm to the blade.

13. The blade as claimed in claim 12 wherein the circular mean camber line coincides with the circular path.
